(19) United States
(12) Patent Application Publication
(10) Pub. No.: US 2005/0061097 A1
(43) Pub. Date: Mar. 24, 2005

(54) Orthogonal transmission

(75) Inventors: Takashi Haga, Ohbu-shi (JP); Mitsuhiro Tamura, Ohbu-shi (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Sumitomo Heavy Industries, Ltd.

(21) Appl. No.: 10/946,320

(22) Filed: Sep. 22, 2004

(30) Foreign Application Priority Data
Sep. 24, 2003 (JP) 2003-331729

(51) Int. Cl. F16H 27/02

(52) U.S. Cl. 74/423

(57) ABSTRACT

An orthogonal gear head includes an orthogonal transformation mechanism contained in an independent casing. The orthogonal transformation mechanism comprises a pair of gears, the rotation shafts of which are disposed orthogonally to each other. An internal gear engaged with a pinion of a drive source, is provided as an input shaft of the orthogonal gear head. The internal gear is connected to an end of one of the pair of gears on the side of input.

### BACKGROUND OF THE INVENTION

1. Field of the Invention

The present invention relates to an orthogonal transmission which is used for orthogonally transforming the direction of a rotation shaft in a power transmission path.

2. Description of the Related Art

In driving a driven device such as an industrial robot or a conveyer, there are cases where an orthogonal transformation mechanism is disposed in a power transmission path between a drive source such as a motor and the driven device (refer to, for example, Japanese Patent Laid-Open Publication No. 1998-299840).

The motor is generally long in its axial direction. Thus, often occurs a situation in which the motor becomes installable by transforming the axis direction of the motor in an orthogonal direction to a normal installed posture of the motor, even when the motor is not installable as-is because the existence of the motor is obstructive. When the orthogonal transformation mechanism is disposed in the power transmission path, the installation direction (orientation) of the motor with respect to the driven device is transformed by 90 degrees, so that it is possible to favorably deal with such a situation. In addition, there are cases where the motor becomes installable with high efficiency in installation (that means the case with little wasted space).

Such a situation may also occur when the position of the existing driven device in a production line is changed, in addition to a case where the driven device is newly installed.

As the concrete structure of a gear for the orthogonal transformation mechanism, a bevel gear mechanism, a hypoid gear mechanism, a worm gear mechanism, and the like are widely known. The bevel gear mechanism is inexpensive, but makes much noise. Even if the bevel gear mechanism is employed, when teeth thereof are formed into a helical shape, the noise is reduced.

In accordance with the tendency of improvement and the like in a labor environment and a work environment in recent years, noise reduction is required in this type of orthogonal transformation mechanism. However, from the viewpoints of cost, transmission efficiency, and the like, the fact of a matter is that a gear mechanism with low noise cannot be always adopted as the gear mechanism used in the orthogonal transformation mechanism under present circumstances.

### SUMMARY OF THE INVENTION

In view of the foregoing problems, various exemplary embodiments of this invention provide an orthogonal transmission which ensures a high degree of flexibility in installation by easing the transformation of the direction of a rotation shaft irrespective of an existing device or a newly installed one, and reduces noise while minimizing increase in cost.

To achieve the above object, an orthogonal transmission according to various exemplary embodiments of this invention has an orthogonal transformation mechanism for orthogonally transforming a direction of a rotation shaft in a power transmission path. The orthogonal transformation mechanism is contained in an independent casing as a gear head, and includes a pair of gears rotation axes of which are disposed orthogonally to each other and an internal gear serving as an input shaft of the gear head. A pinion of a drive source is engaged with the inside of the internal gear. The internal gear is connected to an end of one of the pair of gears on the side of input.

According to the various exemplary embodiments of this invention, the orthogonal transformation mechanism is contained in the independent casing as a so-called gear head. Thus, not only when a motor or the like is newly installed, but also when the existing motor or the like which has been installed without problem cannot be installed as-is due to, for example, change in the disposition of existing equipment in a production line or the like, it is possible to easily transform the axis direction of the motor with respect to a driven device by disposing the “gear head” according to the present invention, for example, between the conventional motor (drive source) and a speed reducer.

In the various exemplary embodiments of this invention, noise reduction in the orthogonal transformation mechanism is realized by means of reducing rotational speed (instead of changing a type of orthogonal transformation mechanism). Therefore, it is possible to certainly achieve noise reduction while restraining increases in cost.

Namely, the noise occurring in the orthogonal transformation mechanism is strongly in correlation with the rotational speed during operation. When the rotational speed is high, the noise significantly increases. The present invention focuses attention on this point, and the internal gear is provided as the input shaft of the gear head. Then, the pinion of the motor is inscribed in the internal gear. As a result, the internal gear rotates at quite lower speed than the rotational speed of the pinion (that is, the rotational speed of the drive source). Therefore, by connecting the internal gear to one of the pair of gears, composing the orthogonal transformation mechanism, which gear is on the side of input, it is possible to reduce the rotational speed of the orthogonal transformation mechanism to approximately one-half or lower, so that it is possible to reduce the occurring noise.

Since the pinion is inscribed in the internal gear, it is possible to reduce an amount of offset of the orthogonal transformation mechanism with respect to the pinion. Therefore, it is possible to compactly connect the orthogonal transformation mechanism to the drive source.

In the “orthogonal transformation mechanism” according to the various exemplary embodiments of this invention, the term “orthogonal” includes not only a case where the centers of rotation shafts perfectly intersect such as a bevel gear mechanism, but also a case where the centers of two rotation shafts themselves do not orthogonally intersect though the directions of the centers of the rotation shafts are orthogonally disposed such as a hypoid gear or a worm gear.

According to the various exemplary embodiments of this invention, it is possible to ensure the high degree of flexibility in the installation of the motor and the like irrespective of an existing device or a newly installed one, and to achieve noise reduction with minimizing increase in cost.

### BRIEF DESCRIPTION OF THE DRAWINGS

Various exemplary embodiments of the present invention will be described in detail with reference to the accompanying drawings, wherein:

FIG. 1 is a sectional view of a geared motor to which an orthogonal gear head according to an exemplary embodiment of the present invention is applied;

FIG. 2 is an enlarged view of an essential portion of FIG. 1; and

FIG. 3 is a partly sectional view taken along the line III-III of FIG. 2.

### DETAILED DESCRIPTION OF THE PREFERRED EMBODIMENTS

Various exemplary embodiments of this invention will be hereinafter described with reference to the accompanying drawings.

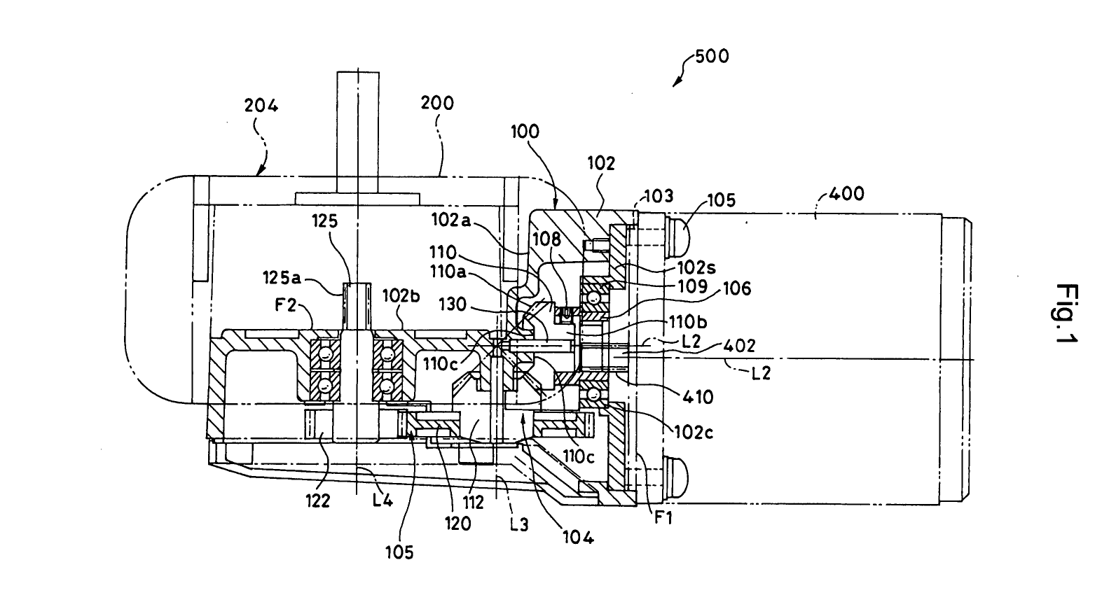

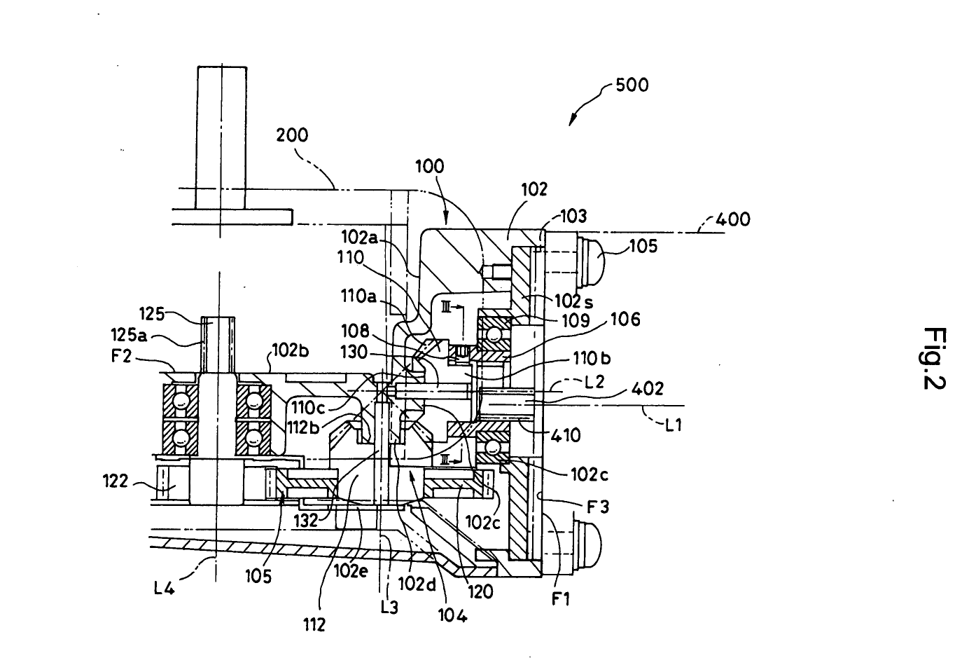

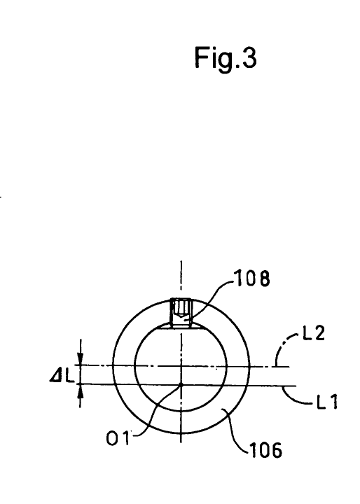

FIG. 1 is a sectional view of a geared motor 500 to which an orthogonal gear head (orthogonal transmission) 100 according to the exemplary embodiment of the present invention is applied. FIG. 2 is an enlarged view of an essential portion of FIG. 1, and FIG. 3 is a partially sectional view taken along the line III-III of FIG. 2.

The geared motor 500 comprises a motor (drive source) 400 and the orthogonal gear head 100. A parallel gear head 200 may be provided in a stage subsequent to the orthogonal gear head 100 if necessary. First, the schematic configuration of the whole device will be described.

A (helical) pinion 410 is integrally formed at an end of a motor shaft 402 of the motor 400.

The orthogonal gear head 100 has an independent casing 102. In the connection surface F1 of the casing 102 to the motor 400, four connection holes 103 are formed to connect the casing 102 to the motor 400. These four connection holes 103 are formed in positions corresponding to vertices of a virtual square in which an intersection point O1 of its diagonal lines coincides with the axis L1 of the pinion 410. Thus, the orthogonal gear head 100 is connectable to the casing 406 of the motor 400 while rotating every 90 degrees in a circumferential direction of the motor shaft 402 with respect to the motor shaft 402 of the motor 400. The motor 400 and the orthogonal gear head 100 are connected with bolts 107 through the connection holes 103.

In the connection surface F2 of the orthogonal gear head 100 facing to the parallel gear head 200, connection holes (not illustrated) are formed in a like manner as those in the connection surface F3 of the motor 400 facing to the orthogonal gear head 100. In other words, the motor 400 and the parallel gear head 200 have respective mutual dimensions so as to be connectable to each other. The parallel gear head 200 can be directly connected to the motor 400 by bypassing the orthogonal gear head 100. In this case, the motor shaft 402 of the motor 400 is disposed in parallel with an output shaft 202 of the parallel gear head 200.

A cross section of the casing 102 including the input and output axes L1 and L2 of the orthogonal gear head 100 is in the shape of a letter L. Most of a casing 204 of the parallel gear head 200 is contained in a space defined by the two surfaces 102a and 102b of the casing 102 corresponding to the shape of the letter L.

Then, the configuration of the orthogonal gear head 100 itself will be described in detail.

The orthogonal gear head 100 has a (helical) internal gear 106, an orthogonal transformation mechanism 104, and a parallel axis gear mechanism 105. The (helical) pinion 410 formed in the motor shaft 402 is engaged with the inside of the internal gear 106. The orthogonal transformation mechanism 104 connected to the internal gear 106 transforms the rotation direction of the internal gear 106 to a direction L3 orthogonal to the axis L2 of the internal gear 106. The parallel axis gear mechanism 105 increases the speed of rotation outputted from the orthogonal transformation mechanism 104. The orthogonal transformation mechanism 104 and the parallel axis gear mechanism 105 are contained in the independent casing 102. The internal gear 106 is supported by a sub-casing 102s of the orthogonal gear head 100 through a bearing 109. The axis L2 of the internal gear 106 is misaligned (offset) with the intersection point O1 of the diagonal lines of the virtual square of the connection holes 103 by a distance ΔL to the axis L1 of the pinion 410.

The orthogonal transformation mechanism 104 comprises a first bevel gear (a gear on the side of input) 110 having straight teeth 110a, and a second bevel gear (a gear on the side of output) 112 having straight teeth 112a.

One end 110b of the first bevel gear 110 is inserted into the internal gear 106 from the opposite side of the pinion 410. The end 110b is connected to the internal gear 106 through a key 108 so as to be integrally rotatable with the internal gear 106. The first bevel gear 110 is rotatably supported by the casing 102 through a first center shaft 130, so that the first bevel gear 110 is rotatable with respect to the axis L2. A recessed portion 110c is formed at an end of the first bevel gear 110, and a projecting portion 102c of the casing 102 makes contact with the recessed portion 110c. As a result, the position of the first bevel gear 110 on one side of the axis direction is determined. The bearing 109 determines the position of the first bevel gear 110 on the opposite side of the axis direction through the internal gear 106.

The second bevel gear 112 is rotatably supported by the casing 102 through a second center shaft 132 so that the second bevel gear 112 rotates around an axis L3 while engaging with the first bevel gear 110. A recessed portion 112b is formed at an end of the second bevel gear 112, too. A projecting portion 102d of the casing 102 makes contact with the recessed portion 112b. As a result, the position of the second bevel gear 112 on one side of an axis direction is determined. A cover portion 102e of the casing 102 determines the position of the second bevel gear 112 on the opposite side of the axis direction.

A first helical gear 120 of the parallel axis gear mechanism 105 is integrally connected to the second bevel gear 112 by press-fitting. The first helical gear 120 is engaged with a second helical gear 122, and the rotation of the second helical gear 122 is taken out as the rotation of an output shaft 125 of the orthogonal gear head 100. The number of teeth of the second helical gear 122 is fewer than that of the first helical gear 120, and hence the first and second helical gears 120 and 122 compose a speed up mechanism. A speed up ratio corresponds to a speed reducing ratio of a speed reducing mechanism which is composed of the pinion 410 and the internal gear 106. In other words, the orthogonal gear head 100 neither decreases nor increases speed on the whole. A helical pinion 125a, the shape of which is the same as that of the pinion 410 of the motor shaft 402, is formed at an end of the output shaft 125.

Each axis is summarized as follows. The axis L1 of the pinion 410 of the motor shaft 402 is in parallel with the axis L2 of the internal gear 106 while being offset (shifted) by ΔL. The axis L2 of the internal gear 106 is common to (coaxial with) the axis L2 of the first bevel gear 110 of the orthogonal transformation mechanism 104. The axis L3 of the second bevel gear 112 of the orthogonal transformation mechanism 104 is disposed orthogonally to the axis L2, and intersects therewith. An axis L4 of the output shaft 125 of the orthogonal gear head 100 is orthogonal to the axis L1 of the motor shaft 402 as a result.

Next, the operation of the geared motor 500 will be described.

When the motor 400 is energized, the pinion 410 formed on the motor shaft 402 rotates around the axis L1. As a result, the internal gear 106, with the inside of which the pinion 410 is engaged, rotates around the axis L2 with reducing speed. The rotation of the internal gear 106 at the reduced speed is transmitted to the first bevel gear 110 through the key 108, and then is transmitted to the second bevel gear 112. In this stage, the axis of the rotation is orthogonally transformed from L2 to L3. The rotation of the first bevel gear 110 and the second bevel gear 112 is slower than the rotation of the motor shaft 402 by an amount corresponding to the speed reducing ratio of the speed reducing mechanism which is composed of the pinion 410 and the internal gear 106. This can reduce engagement noise. Since the engagement noise occurring in the engagement section between the pinion 410 and the internal gear 106 is one between the parallel axis gears, the engagement noise is originally lower than engagement noise between orthogonal gears. The engagement noise hardly becomes problem, because especially the shapes of teeth of the pinion 410 and the internal gear 106 are made helical in this exemplary embodiment.

When the second bevel gear 112 rotates, the first helical gear 120 rotates integrally therewith. Then, the second helical gear 122 engaged with the first helical gear 120 rotates with speedup. The speed up ratio is set in accordance with the speed reducing ratio of the speed reducing mechanism which is composed of the pinion 410 of the motor shaft 402 and the internal gear 106. As a result, the output shaft 125 of the orthogonal gear head 100 rotates at the exactly same speed as the pinion 410 of the motor shaft 402 after all. The shape of teeth of the pinion 125a formed in the output shaft 125 is the same as that of the pinion 410 of the motor shaft 402, and connection holes are formed in the connection surface F2 in the same manner as those in the connection surface F3 of the motor 400. Therefore, when viewing the pinion 125a of the output shaft 125 on the connection surface F2 from the parallel gear head 200 at the subsequent stage or from the side of connected equipment, it looks as if a state identical to that of the pinion 410 of the motor shaft 402 on the connection surface F3 is formed.

Therefore, this orthogonal gear head 100 can be freely inserted into and detached from between the motor 400 and the parallel gear head 200 in accordance with the presence or absence of the necessity of orthogonal transformation, in addition to the fact that the orthogonal gear head 100 itself constitutes the independent casing 102.

The addition of the internal gear 106 does not increase much noise. As compared with this increase in noise, the effect of noise reduction in the whole gear head, due to reduction in the rotational speed of the first and second bevel gears 110 and 112, is much greater. Accordingly, it becomes possible to freely change the direction of setting up the motor 400 in accordance with requirements on a setup condition with hardly increasing the noise, irrespective of whether the motor 400 already exists or is newly installed. Since the internal gear 106 is easily manufactured by conventional gear manufacturing equipment at low cost, increase in cost hardly becomes a problem.

In the foregoing exemplary embodiment, the bevel gear mechanism is adopted in the concrete structure of the orthogonal transformation mechanism, but the present invention is applicable to an orthogonal transformation mechanism which is composed of a hypoid gear mechanism or a worm gear mechanism instead of the bevel gear mechanism, and proper effect can be obtained. When the orthogonal transformation mechanism is composed of, for example, the hypoid gear mechanism which can originally realize low noise, the present invention reduces rotational speed in engagement, so that the noise is further reduced. In the case of the worm gear mechanism, highly setting the speed reduction ratio tends to further decrease efficiency in general. According to the various exemplary embodiments of the present invention, it is possible to set the speed reduction ratio of the worm gear mechanism at low (with high efficiency) by an amount of the speed reduction ratio ensured by the pinion and the internal gear. Hence it is possible to design the orthogonal transformation mechanism so as to obtain a merit, that is, increase in the efficiency. As a matter of course, there are cases where the noise can be further reduced.

In the foregoing exemplary embodiment, the helical internal gear 106 is used as the internal gear. The internal gear, however, does not always have to be helical in the various exemplary embodiments of the present invention, but may be a spur gear.

In the foregoing exemplary embodiment, one end 110a of the first bevel gear (the gear on the side of input) 110 is inserted into the internal gear 106 from the opposite side of the pinion, to connect the first bevel gear 110 to the internal gear 106 in such a manner as to be integrally rotatable with the internal gear 106. However, with relation to the structure of connection between the internal gear and the orthogonal transformation mechanism, the present invention is not limited to the above structure. For example, the relation between inside and outside may be opposite to a case described above, and a connection method such as press-fitting may be adopted instead of connection by the key 108.

In the foregoing exemplary embodiment, the parallel axis gear mechanism 105 having the first and second helical gears 120 and 122 is further provided at the stage subsequent to the orthogonal transformation mechanism 104 in the casing 102. In addition, the parallel axis gear mechanism 105 has the speed up ratio corresponding to the speed reducing ratio of speed reduction actualized by the pinion 410 and the internal gear 106 so that the orthogonal gear head 100 neither decreases nor increases the speed. In the present invention, however, the parallel axis gear mechanism does not always have to be provided at the subsequent stage. Even if the parallel axis gear mechanism is provided at the subsequent stage, the parallel axis gear mechanism does not always have to increase the speed. For example, the parallel axis gear mechanism may actively decrease the speed in accordance with its design.

Furthermore, in the foregoing exemplary embodiment, the connection holes 103 of the casing 102 to the casing 406 of the motor 400 are formed in such positions corresponding to the vertices of the virtual square, in which the intersection point O1 of the diagonal lines coincides with the axis L1 of the pinion 410. In addition, the direction of shifting the internal gear 106 with respect to the pinion 410 is rotatable and selectable at every 90 degrees, and the direction of the output shaft 125 of the orthogonal gear head 100 is rotatable and selectable at every 90 degrees. This structure, however, is not always necessary either. When the connection holes are formed in such positions corresponding to vertices of a virtual rectangle, rotation and selection are carried out at every 180 degrees. When the connection holes are formed in such positions corresponding to vertices of a virtual regular hexagon, rotation and selection are carried out at every 60 degrees.

The present invention is applicable to every power transmission system which needs the orthogonal transformation mechanism for orthogonally transforming the direction of a rotation shaft.

The disclosure of Japanese Patent Application No. 2003-331729 filed Sep. 24, 2003 including specification, drawings and claims is incorporated herein by reference in its entirety.

1. An orthogonal transmission comprising:
an orthogonal transformation mechanism for orthogonally transforming a direction of a rotation shaft in a power transmission path, the orthogonal transformation mechanism including a pair of gears, rotation axes of which are disposed orthogonally to each other;
an internal gear serving as an input shaft of the gear head; and
a pinion of a drive source being engaged with the inside of the internal gear,
wherein the orthogonal transformation mechanism is contained in an independent casing as a gear head, and
the internal gear is connected to an end of one of the pair of gears on the side of input.

2. The orthogonal transmission according to claim 1, wherein
the internal gear is a helical internal gear.

3. The orthogonal transmission according to claim 1, wherein
the one end of the gear on the side of input is inserted into the inside of the internal gear from an opposite side of the pinion to connect the gear to the internal gear so as to be integrally rotatable.

4. The orthogonal transmission according to any one of claims 1, further comprising:
a parallel axis gear mechanism disposed in a stage subsequent to the orthogonal transformation mechanism in the gear head.

5. The orthogonal transmission according to claim 4, wherein
the parallel axis gear mechanism has a speed up ratio corresponding to a speed reducing ratio of speed reduction carried out by the pinion and the internal gear.

6. The orthogonal transmission according to any one of claims 1, wherein
connection holes are formed in the casing of the gear head to connect the gear head to a casing of the drive source, the connection holes are formed in such positions corresponding to vertices of a virtual polygon, an intersection point of diagonal lines of the virtual polygon coincides with an axis of the pinion.
